(19) United States
(12) Patent Application Publication
(10) Pub. No.: US 2014/0266557 A1
(43) Pub. Date: Sep. 18, 2014

(54) Inherently Balanced Phase Shifting AutoTransformer

(71) Applicant: Jacob Justice, Lubbock, TX (US)

(72) Inventor: Jacob Justice, Lubbock, TX (US)

(21) Appl. No.: 14/214,165

(22) Filed: Mar. 14, 2014

Related U.S. Application Data
(60) Provisional application No. 61/789,256, filed on Mar. 15, 2013.

(51) Int. Cl. H01F 30/02; H01F 30/06

(52) U.S. Cl. CPC H01F 30/02; H01F 30/06
USPC 336/221

(57) ABSTRACT

A device and method of use for a phase shifting autotransformer is disclosed which has inherently balanced impedance characteristics. This is achieved by having the coil windings structured such that the following two requirements are met. Equivalent winding sections must have essentially equal lengths, occupy equal radial volumes and therefore exhibit equal resistances. Secondly, semi-bifilar or full-bifilar construction ensures that the inductances generated in each section essentially cancel each other out, minimizing the reactive component of the impedance such that it can be dominated by the resistive component in operation. As a result of these two design elements, the 5th and 7th harmonics that dominate 6-pulse systems can be attenuated much more effectively than was previously possible, improving both the overall performance of the phase shifting autotransformer itself, as well as its associate system.

### CROSS-REFERENCE TO RELATED APPLICATIONS

This application claims the benefit under Title 35 United States Code §119(e) of U.S. Provisional Patent Application Ser. No. 61/789,256; Filed: Mar. 15, 2013, the full disclosure of which is incorporated herein by reference.

### STATEMENT REGARDING FEDERALLY SPONSORED RESEARCH OR DEVELOPMENT

Not applicable

### THE NAMES OF THE PARTIES TO A JOINT RESEARCH AGREEMENT

Not applicable

### INCORPORATING-BY-REFERENCE OF MATERIAL SUBMITTED ON A COMPACT DISC

Not applicable

### SEQUENCE LISTING

Not applicable

### FIELD OF THE INVENTION

The present invention generally relates to a device and method of use directed to transformers. More specifically, the present invention relates to a device and method of use for a phase shifting autotransformer.

### BACKGROUND OF THE INVENTION

Without limiting the scope of the disclosed device and method, the background is described in connection with a novel device and approach to provide improved phase shifting autotransformer performance.

The field's prior art reflects many approaches and devices in providing a means for improved transformer performance. Various design and construction techniques have been implemented on common concentrically wound hexagonal phase-shifting autotransformer connections with the goal of improved performance. Specifically, improved harmonic cancellation through closely balanced output currents facilitated by more closely impedance-matched paths between the input and the output. While these improvements focus on a lineage of development on one topology, it should be noted that the aforementioned techniques can be easily implemented on other topologies as well.

A first example of an autotransformer winding in the prior art is illustrated in FIG. 1, a conventional concentric step-up phase shifting autotransformer winding. In this example, the inside and outside winding sections make up the short winding of the hexagonal topology. The device input is the center point of the short winding. The device outputs are at the apexes. With respect to each phase, each converter is fed by one of these two windings. The resistive impedance difference between the inside and outside sections is inescapable and unavoidable when wound in a purely concentric configuration. In the case of no reactive impedance component, there is an inherent unbalance between the two outputs as a result of this. A rectifier load represents a sequential series of single phase loads. Since the coil is not linearly loaded, the overall inductive reactance generated by loaded windings changes as different windings become loaded and unloaded, potentially compounding the inherent resistive impedance imbalance issues. The result is unbalanced output currents and therefore poor harmonic cancellation. This effect is substantially more detrimental as the capacity increases. The advantage of this winding arrangement is that it is easy to produce for any given topology. The disadvantage of this particular topology is that it produces an inherent voltage increase between the input and output. Practically, this can result in DC bus overvoltage conditions in systems where the voltage cannot be lowered by the distribution transformers that feed this device.

A second example of an autotransformer winding in the prior art is illustrated in FIG. 2, a conventional concentric unity gain phase shifter with autotransformer winding. In this example the only major variation is in the topology itself. The same basic conventional concentric winding strategy is used. An additional pair of conducting sections are built into the long winding of the topology. This allows an essentially unity gain (or even step-down) hexagonal topology to be produced, alleviating concerns of voltage step-up going into the drive and potential DC bus overvoltage conditions. The downside to this method is an even more erratic reactive impedance component. Furthermore, the resistive variation between inside and outside windings is further increased over the previous design, as additional winding sections and their accompanying insulation produces a larger overall coil.

A third example of an autotransformer winding in the prior art is illustrated in FIG. 3, a conventional concentric unity gain phase shifter with better resistance balance and higher reactance autotransformer winding. In this example, the only variation is in the winding section arrangement. It can be looked at as an improvement on the transformer show in FIG. 2. By relocating the two main short winding conducting sections to the inside, the resistive difference between the two windings is improved substantially, although it is still far from perfect, particularly with larger capacity devices. Also, the two long winding conducting sections are relocated to the outside to more closely match those two windings in length. The reactive impedance characteristics are in no way improved over the previous design. At various times in the conduction cycle, a given coil might “appear” to look like a low high low (LHL) design, and at other adjacent intervals a low high (LH). The instantaneous overall impedance variation due to reactive component fluctuation could be dramatic and strongly degrade device performance. The end result is a device with an improved resistance balance and typical, poor reactive balance. At low capacities, with low overall inductances, it provides relatively low harmonic distortions in comparison to FIG. 2, but quickly falls off as the capacity, and thus coil size, goes up.

A last exampled of an autotransformer winding in the prior art is illustrated in FIG. 4, a conventional concentric unity gain phase shifter with good resistance balance and lower reactance autotransformer windings. In this example an improvement is made to the reactive impedance characteristics of the design in FIG. 3. By splitting each conducting winding section into two parts and placing one on the inside and one on the outside of the (induced) long winding, the coil's reactive impedance characteristics always resemble that of a low high low (LHL) arrangement, regardless of whether or not one, or both outputs are conducting on that phase. Thus, the large spikes in reactive impedance during certain conduction intervals are exchanged for smaller shifts in the reactive impedance. The end result is a device with an improved resistance balance and an improved reactive balance. This would work better at larger capacities than the former, but would still be far from a perfect output current balance and optimal harmonic performance. The major drawback to this method is complexity. Moderate performance improvements are exchanged for major complications in winding and connection.

While all of the aforementioned devices may fulfill their unique purposes, none of them fulfill the need for a practical and effective means of optimizing the impedance balancing and harmonic attenuation performance characteristics of a phase shifting autotransformer.

The present invention therefore proposes a novel device and method of use for dramatically improving the output current balancing and harmonic attenuation performance in phase shifting autotransformers.

### BRIEF SUMMARY OF THE INVENTION

The present invention, therefore, provides a device and method of use to provide improved performance in phase shifting autotransformers.

In one embodiment, the phase shifting autotransformer has an internal winding layout and construction that provides equal magnitude output currents to each converter fed by the unit; in other words, it is inherently balanced, or built into the device. It does not require the use of external impedance matching resistive and/or inductive devices. The phrase inherently balanced is characterized by the following two characteristics. The first requirement is that the phase shifting transformer having multiple identical windings structured in such a manner that each output phase has an equal resistance path with respect to the input as any other output phase. That is, every section of a given topology is built within the same radial volume about the given core and thus is the same length as those on the adjacent phases. Second, the coil windings are structured such that the reactive component of the impedance is minimized, so as not to cause impedance variation between various commutation intervals. This is done through the use of semi-bifilar and full-bifilar winding configurations in which the inductance generated in one coil would essentially cancel out most, if not all, of the inductance generated in another identically wound coil of opposite polarity. With a negligible effective reactive impedance, the current balancing characteristics are almost entirely dependent on the resistive impedance balance between the two converter outputs and the input, which as stated, is built into the unit. As a result of more closely balanced output currents, greater 5^{th} and 7^{th} harmonic cancellation is achieved, resulting in a lower total harmonic current distortion figure for the phase shifting autotransformer and its associated system.

In summary, the present invention discloses an improved device and method of use to improve the performance in phase shifting transformers. More specifically, the present invention relates to a device and method of use for a phase shifting autotransformer that has inherently balanced impedance characteristics.

### BRIEF DESCRIPTION OF THE SEVERAL VIEWS OF THE DRAWINGS

For a more complete understanding of the features and advantages of the present invention, reference is now made to the detailed description of the invention along with the accompanying figures in which:

FIG. 1 is a prior art application of a conventional concentric step-up phase shifter autotransformer winding;

FIG. 2 is a prior art application of a conventional concentric unity gain phase shifter with autotransformer winding;

FIG. 3 is a prior art application of a conventional concentric unity gain phase shifter with better resistance balance and higher reactance autotransformer winding;

FIG. 4 is a prior art application of a conventional concentric unity gain phase shifter with good resistance balance and lower reactance autotransformer winding;

FIG. 5 is an inherently balanced autotransformer with semi-bifilar windings in accordance with embodiments of the disclosure;

FIG. 6 is an inherently balanced autotransformer with full bifilar windings in accordance with embodiments of the disclosure;

FIG. 7a illustrates how to divide the coil sections into two equal groups for an inherently balanced autotransformer with full bifilar windings in accordance with embodiments of the disclosure.

FIG. 7b illustrates how to divide the coil sections into two equal groups for an inherently balanced autotransformer with semi-bifilar windings in accordance with embodiments of the disclosure.

### DETAILED DESCRIPTION OF THE INVENTION

Disclosed herein is an improved device and method of use for improving phase shifting autotransformer performance. The numerous innovative teachings of the present invention will be described with particular reference to several embodiments (by way of example, and not of limitation).

Reference is first made to FIG. 5, an inherently balanced autotransformer with semi-bifilar windings. In this illustration the layout of the phase shifting autotransformer is shown. This is the basic topology of the inherently balanced 12-pulse unit topology and connection diagram. Each coil winding is divided into top and bottom halves. In this illustration the short and leaf winding conducting sections (large wire) are shown as well as the induced, imbalance current-carrying long windings (small wire).

The term inherently balanced refers to the construction topology of the phase shifting autotransformer where each section (segment of the topology that represents a continuous winding between two taps or line leads) in the topology is divided into two equal subsections (or a multiple thereof), regardless of the presence of symmetry in the topology. The division is not necessarily a division through the middle of the topology, as would be the case in a hexagonal or fork type connection, but a division of each individual section. This approach allows other topologies such as polygon designs that are not symmetrical to have the inherently balanced topology structure implemented. Each of the resultant coils is electrically and physically identical (although the taps may exit in different locations). This results in an inherently identical resistance between each of the corresponding winding sections. The topology is connected in such a manner so as to produce essentially an equal resistance between output phases in relation to input phases.

With the coils oriented as such, for an inherently balanced phase shifting autotransformer, that is two identically constructed coils, vertically oriented about a common core, with the bottom coil physically flipped upside down, the windings are essentially bifilar. This produces the same electromagnetic effect as the bottom coil being wound identically, but in the opposite direction. The simplest embodiment of a bifilar winding is produced when two adjacent conductors wound on a common core carry equal (or common) currents in opposite directions. Another embodiment of a bifilar winding is produced such that two otherwise identical coils wound in opposite directions on a common core carry currents in the same direction. In either case, the magnetic field produced by one conductor (or winding) essentially cancels out that produced by the other. This type of construction produces a very low inductance and therefore a low (inductive) reactance, allowing the resistive component of the impedance to dominate the overall impedance and facilitate an optimal current balance between the device outputs. With very small conductors, the fields can be more closely overlapped within the same space and a very effective bifilar winding can be produced. Due to the size of the conductors in practical power equipment, this inductance cancellation is not perfect, but it is enough to allow the inherently balanced resistive components of the impedance to dominate the overall impedance and control (balance) the flow of current to the converters attached at the device outputs.

Reference is next made to FIG. 6, an inherently balanced autotransformer with full bifilar windings. In this illustration, every single section in the topology is divided into two, equal turn pieces. Each half section has the same number of turns, carries the same current and occupies the same radial volume (albeit at a slightly different vertical height). The halves with like polarity are grouped into identical pairs of concentric coils. In order to maintain an ideal, inherent resistive balance, an additional pair of coils is required in comparison to the semi-bifilar arrangement. The full bifilar arrangement provides the lowest inductive reactance possible, while still maintaining the critical resistance balance between the input and the two converter outputs.

Reference is next made to FIGS. 7a and 7b, an inherently balanced autotransformer with semi-bifilar and full bifilar windings illustrating how to divide the coils. It should be noted that when using a step-up hexagonal autotransformer topology (as seen in FIG. 1), each phase is responsible for directly feeding two converters. In contrast, when using a unity gain hexagonal autotransformer topology (as seen in FIG. 2), each phase is responsible for directly feeding two converters, as well as indirectly feeding another two. It can be seen that the full bifilar arrangement of FIG. 6 requires 2 pairs of coils, one for each converter that is directly fed by the topology. FIG. 7a illustrates how to divide the topology into paired sections that carry the same current when using a full bifilar winding arrangement; there is one resultant half-section for the top and one for the bottom, with respect to each directly fed converter group. This is done so that any ampere-turns generated by a given current flowing in the top winding can be matched, and therefore cancelled by those generated by the same current flowing in the bottom winding. This results in the smallest possible effective reactive impedance component. When built like this, every short, long and leaf winding in the topology are exactly the same length, respectively. When a current moves through the phase shifter, it travels through one short winding, one leaf winding, into rectifier, through the DC-load, out of the rectifier into another leaf winding, and lastly into another short winding before exiting on one of the adjacent phases. Since all of the short windings are the same length, and all of the leaf windings are the same length, the input to output resistive impedance component is identical for all 6 phases. Thus, the equal resistance phase impedances dominate the negligible reactive impedances and allows an optimal current balance between the two converters at all conduction intervals. FIG. 7b illustrates how to divide the topology when using a semi-bifilar winding arrangement. With respect to the phase shifter, the rectifier can be seen as a sequence of single phase loads. Thus, for any given conduction interval, two of the three phases in each output are conducting. Since there is one rectifier for each of the two three-phase outputs, that means that four of the six phases are conducting during any given conduction interval. Since each phase shifter directly feeds two outputs through the leaf windings and indirectly feeds another two through the short windings, that means that at the very least, one of the conducting windings in each coil is conducting. This allows ampere-turns in one coil to potentially cancel those in the other, assuming both leaf windings and/or both short windings are conducting. The long winding carries the induced imbalance current. Since it is located in the same radial volume for each coil, each piece is the same resistance and all the ampere-turns generated by the top always cancel with those generated by the bottom. A measureable reactance is generated anytime a leaf or a short winding section is conducting in one coil and not the other. For the instances in which only one leaf winding is conducting, the resulting inductance generated is very small, because there are only a few turns in this winding section. For the instances in which only one short winding is conducting, the resulting inductance generated is measureable, but still small in relation to the total system inductance and therefore tolerable. For these reasons, the output current balancing capability of a phase shifting transformer is largely dependent on the resistive balance between the input and the outputs. The semi-bifilar arrangement provides a simple, yet effective means of providing optimal performance for most practical capacities in addition to the benefit of a dramatically simpler construction, particularly when compared to previous methods.

In brief, the present invention relates to a device and method of use to provide improved performance in phase shifting autotransformers. Most well designed/constructed conventional topologies achieve total harmonic distortion (THID) levels around 10%. Most poorly designed/constructed conventional topologies like the one depicted in FIG. 1 might perform comparably at smaller capacities, but can reach levels of 20% or more, at full load, as device capacity increases. The disclosed device achieves THID levels in the 6-7% range with no additional added series inductance (i.e. line reactor filter). That is, the invention, produces lower THID values as a result of its improved impedance balancing characteristics.

The disclosed device and method of use is generally described, with examples incorporated as particular embodiments of the invention and to demonstrate the practice and advantages thereof. It is understood that the examples are given by way of illustration and are not intended to limit the specification or the claims in any manner.

To facilitate the understanding of this invention, a number of terms may be defined below. Terms defined herein have meanings as commonly understood by a person of ordinary skill in the areas relevant to the present invention. Terms such as “a”, “an”, and “the” are not intended to refer to only a singular entity, but include the general class of which a specific example may be used for illustration. The terminology herein is used to describe specific embodiments of the invention, but their usage does not delimit the disclosed device or method, except as may be outlined in the claims. Consequently, any embodiments comprising a one piece or multi piece device having the structures as herein disclosed with similar function shall fall into the coverage of claims of the present invention and shall lack the novelty and inventive step criteria.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific device and method of use described herein. Such equivalents are considered to be within the scope of this invention and are covered by the claims.

All publications and patent applications mentioned in the specification are indicative of the level of those skilled in the art to which this invention pertains. All publications and patent application are herein incorporated by reference to the same extent as if each individual publication or patent application was specifically and individually indicated to be incorporated by reference.

In the claims, all transitional phrases such as “comprising,” “including,” “carrying,” “having,” “containing,” “involving,” and the like are to be understood to be open-ended, i.e., to mean including but not limited to. Only the transitional phrases “consisting of” and “consisting essentially of,” respectively, shall be closed or semi-closed transitional phrases.

The device and/or methods disclosed and claimed herein can be made and executed without undue experimentation in light of the present disclosure. While the device and methods of this invention have been described in terms of preferred embodiments, it will be apparent to those skilled in the art that variations may be applied to the device and/or methods and in the steps or in the sequence of steps of the method described herein without departing from the concept, spirit, and scope of the invention.

More specifically, it will be apparent that certain components, which are both shape and material related, may be substituted for the components described herein while the same or similar results would be achieved. All such similar substitutes and modifications apparent to those skilled in the art are deemed to be within the spirit, scope, and concept of the invention as defined by the appended claims.

What is claimed is:

1. A transformer comprising:
each section in the topology divided into two subsections or a multiple thereof with each said subsection having the same number of turns and constructed within the same radial volume about the given core producing equal said subsection lengths as those on adjacent phases.

2. The transformer of claim 1, wherein said transformer is constructed using a hexagonal topology.

3. The transformer of claim 1, wherein said transformer is constructed using a fork topology.

4. The transformer of claim 1, wherein said transformer is constructed using a polygon topology.

5. The transformer of claim 1, wherein said transformer is constructed having said windings in a semi-bifilar arrangement.

6. The transformer of claim 1, wherein said transformer is constructed having said windings in a full-bifilar arrangement.

7. The transformer of claim 1, wherein said transformer is constructed using a hexagonal topology and having said windings in a semi-bifilar arrangement.

8. The transformer of claim 1, wherein said transformer is constructed using a hexagonal topology and having said windings in a full-bifilar arrangement.

9. The transformer of claim 1, wherein said transformer is constructed using a fork topology and having said windings in a semi-bifilar arrangement.

10. The transformer of claim 1, wherein said transformer is constructed using a fork topology and having said windings in a full-bifilar arrangement.

11. The transformer of claim 1, wherein said transformer is constructed using a polygon topology and having said windings in a semi-bifilar arrangement.

12. The transformer of claim 1, wherein said transformer is constructed using a polygon topology and having said windings in a full-bifilar arrangement.
